(19) United States
(12) Patent Application Publication
(10) Pub. No.: US 2026/0328962 A1
(43) Pub. Date: Oct. 22, 2026

(54) DOWNHOLE TOOL ELECTROMAGNETIC TELEMETRY TECHNIQUES

(71) Applicant: SCHLUMBERGER TECHNOLOGY CORPORATION, Sugar Land, TX (US)

(72) Inventors: Carlos URDANETA, Sugar Land, TX (US); Arnaud JARROT, Clamart (FR)

(21) Appl. No.: 19/106,638

(22) PCT Filed: Aug. 28, 2023
(86) PCT No.: PCT/US2023/031229

§ 371 Date: Feb. 26, 2025

Related U.S. Application Data
(60) Provisional application No. 63/373,627, filed on Aug. 26, 2022.

(51) Int. Cl. G01V 11/00; E21B 47/13; H04B 13/02

(52) U.S. Cl. CPC G01V 11/002; E21B 47/13; H04B 13/02

(57) ABSTRACT

An electromagnetic telemetry system to support communications at an oilfield. The system may include unique modes of encoding and decoding acquired signal data between a down-hole tool and a surface unit for attenuation of noise from the data. In one embodiment, a mode of speech separation may be utilized to further enhance reliability of the acquired signal data.

### CROSS REFERENCE PARAGRAPH

This application claims the benefit of U.S. Provisional Application No. 63/373,627, entitled “DOWNHOLE TOOL ELECTROMAGNETIC TELEMETRY TECHNIQUES,” filed Aug. 26, 2022, the disclosure of which is hereby incorporated herein by reference.

### BACKGROUND

Exploring, drilling and completing hydrocarbon and other wells are generally complicated, time consuming and ultimately very expensive endeavors. As such, tremendous emphasis is often placed on well applications and monitoring that rely heavily on communications or telemetry. That is, monitoring a well's condition or telemetry for sake of running an application is often of critical importance. As described below, such telemetry is often provided by way of electromagnetic communications.

Traditionally, coiled tubing supported telemetry often utilizes optical fiber telemetry which can face issues in terms of structural robustness. Drilling applications often utilize electromagnetic telemetry but which fails to account for the need for noise attenuation or source separation. Nevertheless, alternatives such as mud-pulse communications may not be available where the well is in a state of underbalanced pressure.

Electromagnetic (EM) downhole tool telemetry has the potential to yield the greatest cost savings over other methods such as optical, mud pulse, power-line communication, and acoustic telemetry. However, its reliability is challenged in wellsites with large formation conductivity extremes, rig noise, and tool depth. As a result, conventional methods incur additional hardware costs to improve their reliability, such as by adding redundancy with a different telemetry method or by making measurements closer to the tool from an adjacent well.

A primary advantage of EM telemetry over the noted alternatives is that it does not require deployment of a cable or pressurized mud between the tool and surface to achieve communication. This means there are no constraints on surface pump rates, and it allows for telemetry to occur during disconnection of pipes and in an open hole environments. This makes electromagnetic telemetry a good choice for underbalanced drilling, as noted above, where the pressure in the wellbore is kept lower than the static pressure of the formation being drilled. Even where mud pulse communications are available, these methods may suffer from wear associated with the contact between the pulsing mechanism and the mud, as well as from the risk of sticking and plug events. Telemetry methods that use cables understandably have an associated hardware cost proportional to the depth of the well. The cost is exacerbated by inspection and maintenance of the cable as it wears over time. Acoustic methods suffer from fast signal attenuation through the pipe, which requires associated repeater hardware to be placed along the pipe. Ultimately, the lack of pressurized mud, moving parts, cables, and repeaters, means that electromagnetic telemetry has the potential to yield the lowest cost of ownership.

Typical EM tools are based on dipole antenna designs acquired at surface stakes that measure the voltage difference between the stakes and the wellhead. As the signal travels from an EM module of the tool to the surface, it is attenuated by the conductive properties of the formation. For example, either very high or very low conductivity formations can severely attenuate the signal. Additionally, the rig has a lot of other equipment such as motors and power lines that generate a significant amount of noise. Further, some wells require reaching depths exceeding tens of thousands of feet, which adds more attenuation due to the formation conductivity. As a result, by the time the signal is acquired at the surface, it can attenuate to as low as 1 μV while the rig noise level can be in the order of 250 μV. This may render it nearly impossible to decode the signal at the surface without yet additional hardware. Typical methods to address this are to either switch to a backup telemetry mechanism, such as mud pulse, or to deploy a cable and an electrode in an adjacent well to measure the signal closer to the tool.

### SUMMARY

A method for conveying electromagnetic communications downhole in an oilfield environment is detailed. The method may include utilizing a tool in a well that includes communications with equipment at a surface of the oilfield. An electromagnetic signal may be transmitted between the tool and the equipment. Further, noise of the environment may be attenuated from the signal. This may include encoding the noise and the signal at a database which serves as an abstract space. Thus, a processor of the surface equipment may be utilized to run the abstracted noise and the signal through a decoder from the database for filtering the noise from the signal. In an alternate embodiment, the attenuation may be achieved by utilizing the processor for source separation between the signal and substantially all other electromagnetic detections.

### BRIEF DESCRIPTION OF THE DRAWINGS

FIG. 1 is a side schematic view of a toolstring in a well where electromagnetic communications are employed with an embodiment of attenuation.

FIG. 2 is a chart depicting a spectrogram for electromagnetic signals following application of an initial filtering for signals outside of a predetermined range.

FIG. 3 is chart depicting a spectrogram for electromagnetic signals upon utilization of a deep denoising autoencoder (DDAE) to confirm frequency readings.

FIG. 4 is another chart depicting a spectrogram for electromagnetic signals upon utilization of another embodiment of a DDAE.

FIG. 5 is a representative layout of charts depicting an embodiment of source separation along a frequency spectrum applied to downhole electromagnetic communication readings.

FIG. 6 is another representative layout for charts depicting an embodiment of source separation presented in terms of time series.

FIG. 7 is a representative layout in the form of charts reflecting an impact of source separation in terms of frequency.

FIG. 8 is a representative layout in the form of charts reflecting DDAE implications as applied to frequency separation.

FIG. 9 is a representative layout in the form of charts reflecting DDAE implications as applied to source amplitude.

FIG. 10 presents an embodiment of charts reflecting source separation along eight different surface location stake readings.

FIG. 11 presents the embodiment of FIG. 10 employing eight different stake readings upon application of a DDAE technique.

FIG. 12 presents charts that reflect the recorded performance in terms of source separation.

FIG. 13 presents a chart that reflects consistency of DDAE recorded performance across an array of various size and placement locations for stakes at the oilfield surface.

FIG. 14 presents a chart that reflects the overall impact of DDAE where a single stake position is employed.

FIG. 15 is an overview schematic similar to that of FIG. 1 where downhole tool electromagnetic telemetry source acquisition is set up for taking readings.

FIG. 16 is a chart depicting the acquisition of electromagnetic readings where random and coherent noise are attenuated according to encoding and decoding and source separation technique embodiments.

FIG. 17 is a depiction of charts to illustrate an embodiment of an encoder-decoder technique for attenuating electromagnetic noise with deep-denoising unsupervised learning.

FIG. 18 is a schematic of an embodiment of attenuating noise from electromagnetic communications with a dual-path recurrent neural network.

FIG. 19 is a chart series depicting an embodiment of frequency separation for noise attenuation.

FIG. 20 is a chart series depicting an embodiment of denoising and the impact on source amplitude.

FIG. 21 is a chart series depicting an impact on denoising techniques in light of various numbers of stakes utilized for acquiring electromagnetic readings.

FIG. 22 is a chart comparison for denoising in light of utilization of a single stake for acquiring electromagnetic readings.

FIG. 23 is a chart series depicting an impact on denoising based on array length and location in light of a two stake reading embodiment.

FIG. 24 is a chart depicting an embodiment of source separation examined in time series.

FIG. 25 is a chart series depicting denoising for electromagnetic communications with a DPRNN optimized model.

FIG. 26 is a chart series depicting denoising for electromagnetic communications with a DPRNN technique where overlapping frequencies are present.

FIG. 27 is a chart series depicting a DPRNN technique and an impact of source amplitude.

FIG. 28 is a chart series depicting a DPRNN technique and an impact of the number of stakes employed for electromagnetic readings.

### DETAILED DESCRIPTION

The present disclosure outlines a novel and non-obvious architecture and techniques for electromagnetic telemetry over a line running through a well at an oilfield. In one embodiment, deep-denoising autoencoder (DDAE), which is a semi-unsupervised learning architecture may be used to attenuate noise in two-dimensional time-series seismic/electromagnetic telemetry data. For example, synthetic data may be utilized as a label for supervised learning of clean data features with a supervised loss function set to minimize root mean squared error (RMSE) between the denoised output and the clean target signal. Further, previous weights may be utilized during unsupervised learning to attenuate noise on field data with an unsupervised loss function set to minimize correlation between the denoised output and the removed noise.

For one embodiment, a deep-denoising unsupervised learning (DDUL) network may be utilized to attenuate noise in either two- or three-dimensional seismic data and take advantage of certain architectural improvements on top of DDAE. This technique adds skip blocks between the encoder and decoder sections of the model, which improves the extraction of seismic data features and avoids excessive training parameters caused by hidden layer stacking. This may also apply a patching technique that structures the training data to produce some overlap and, as a result, expands the number of training samples, which further improves training. The fully unsupervised feature may be particularly useful in the realm of EM telemetry as it enables overcoming the common challenge of not having enough training data or clean labels from a wellsite with EM telemetry. This may render it possible to update the model for rapidly changing wellsite conditions.

Another proposed architecture is for the dual-path transformer network (DPT-Net) with end-to-end supervised time-domain speech separation two-dimensional time-series data. Its architecture consists of encoder, separation, and decoder layers. This combined concept adds an improved source transformer in the separation layer that makes use of recurrent neural networks to learn the order of information in speech sequences without positional encodings. Further, the dual path structure makes the model suitable for extremely long sequences, which is a valuable feature in EM telemetry.

With these separate concepts in mind, it is worth noting that the nature of the oilfield and the particular well involved may present particular advantages or disadvantages of one architecture or another which may change depending on the specific downhole location involved in the telemetry. That is, while lack of attenuation may present a challenge to one segment of a communication line, another segment, perhaps thousands of feet away and in a very different downhole and formation environment may face low frequency issues, for example. As a result, the ability to tailor one EM telemetry system for a line traversing such vast depths and varying environments renders embodiments of techniques and combinations thereof as detailed herein of particular benefit.

For one embodiment the proposed method is to be able to attenuate random rig noise n(t) within the EM telemetry signal band (1-25 Hz). This is combined with separation of the EM tool signal s(t) from other coherent signals x(t) in the acquired surface signal v(t) such as coherent noise and other interfering telemetry signals, which is the input data to the model.

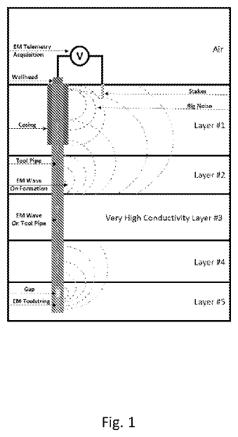

Continuing now with reference to FIG. 1, the input signal is a voltage measurement between the wellhead where the tool is deployed, and a ground or surface stake installed at the wellsite, perhaps several hundred feet away. Included with other surface equipment may be a surface control unit. In practice, several surface stakes may be installed and acquired to increase signal-to-noise (SNR) readings at the surface control unit through spatial diversity. Therefore, the total signal acquired at surface v(t) from M distinct surface stakes where sₘ(t), xₘ(t), and nₘ(t) are respectively the EM tool signal, other coherent signals, and perhaps rig and other noise from surface equipment acquired by the stake number m can be expressed as follows:

$$v ( t ) = {\sum }_{m = 1}^{M} {s}_{m} ( t ) + {x}_{m} ( t ) + {n}_{m} ( t ) \qquad ( 1 )$$

All three deep-learning (DL)-based architectures for a processor of the surface unit may make use of an autoencoder structure, which consists of an encoder stage and a decoder stage. The encoder stage is composed of multiple layers that compress the acquired data from a database of the unit into an embedded abstraction to extract the EM telemetry features f(t) from the input surface stake data v(t) denoted in equation (2) below. One dense layer is used in (2) and subsequent formulations for a simplified representation, but multiple sequential layers are adopted for different scenarios. The decoder stage (3) is structurally opposite to the encoder stage, and its role is to learn how to convert the abstract features f(t) from the encoder back to a reconstructed denoised representation rv(t) in the same domain as the input data v(t).

Both structures make use of an activation function A. The DDAE found optimal performance with a rectifier linear unit activation function (ReLU), whereas the DDUL found it optimal to use an ReLU activation function with a predetermined leak, for example, a leak constant of 0.2 may be utilized. The encoder uses weight matrices Wₑ, and biases bₑ. The decoder uses weight matrices W_{d}, and biases b_{d}.

f(t)=A(Wₑ×v(t)+bₑ) (2)

rv(t)=A(W_{d}×f(t)+b_{d}) (3)

The encoding process is done in an unsupervised manner in both the second step of DDAE and in the DDUL by setting the input data v(t) as both the input and the target during training. Thus, the decoder aims to capture all features of the data in an abstract representation without a clean target. This process can remove noise from the abstract representation because the neural network focuses its attention in capturing coherent signals into the abstract representation during training. The first step of the DDAE does supervised training in the decoder with the input data v(t) and a clean EM telemetry source target c(t). In practice, the clean source c(t) may be a challenge to find for large datasets and is generally constructed in a synthetic manner. Then, DDAE uses the weights found during the first supervised training step as a starting point in the second unsupervised step, which is identical to the unsupervised decoder step previously explained. The benefit of doing the first supervised training as a starting point for the unsupervised step of the DDAE, which is an application of transfer learning, is that it may reuse successful features from previous datasets, and therefore, it may improve over time as more wellsites use this technique.

The DPT-Net architecture differs from the DDAE and DDUL in that between the encoder and decoder layers, an additional separation layer is implemented (4). The separation layer applies supervised learning to one separate neural network for each source target of interest to learn corresponding mask features m(t) that allow separating different coherent sources x(t) from the EM telemetry signal s(t) in the input data v(t). In our case, there is only one source target of interest, and it is the EM telemetry tool signal s(t). The separation layer makes use of similar activation function A, weight matrices W, and biases b. Then, the decoder stage of the DPT-Net (5), which is structurally opposite to the encoder stage, learns how to convert the abstract features of the separated source m(t) from the separator output back to a reconstructed representation rs(t) of the isolated EM telemetry signal s(t) in the same domain as the input data v(t).

m(t)=A(Wₛ×f(t)+bₛ) (4)

rs(t)=A(W_{d}×m(t)+b_{d}) (5)

In this section, DDAE and DDUL are used to attenuate data from one field dataset and from one synthetic dataset. The field dataset consists of 1,161,290 data points sampled at 160 Hz from eight surface stakes at different locations and distances from the wellhead. The first hour of the dataset is split between training and validation, and the second hour of the dataset is used for testing. The field dataset contains interfering telemetry signals with a carrier frequency of 8 Hz and a bit rate of 16 bps using quadrature phase shift keying (QPSK) modulation. The synthetic data set was constructed from the field dataset by generating a synthetic EM source sₖ(t) with 20 Hz carrier frequency and a bit rate of 8 bps, 1 mV amplitude, and QPSK modulation (6) where Eₛ is the energy per symbol, fₛ is the symbol rate, f_{c} is the carrier frequency, and k is the symbol transmitted. In reference to (1), a synthetic mixture v(t) was generated by mixing a synthetic source s(t) with real field data for other coherent sources x(t) and rig noise n(t). The same synthetic source data s(t) was added to the field data from all eight stakes, which is assumed to be detected by all stakes with negligible amplitudes and phase rotation changes.

$$s ( t ) = \sqrt{2 {E}_{s} {f}_{s}} cos ( 2 π {f}_{c} t + ( 2 k - 1 ) \frac{π}{4} ) , k = 1 , 2 , 3 , 4$$

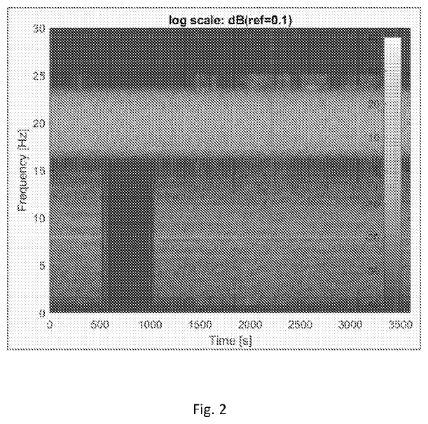

Given that the EM telemetry signal band is of very low frequency (1-25 Hz) a traditional bandpass filter was first used to filter the signals outside of this range and the resulting spectrogram of the noisy input data from the synthetic dataset from stake 1 is shown in FIG. 2.

To evaluate SNR, we use the ratio of the power of the ground truth s(t) to the power of the difference between the ground truth s(t) and the denoised output rs(t).

$$SNR = 20 log \frac{{‖ s ( t ) ‖}_{2}^{2}}{{‖ s ( t ) - rs ( t ) ‖}_{2}^{2}}$$

Additionally, we may evaluate the energy per bit to noise power spectral density ratio in decibels, Eb/NO. Eb is the energy per bit, and No is the noise spectral density.

$$Eb / N 0 = 20 log \frac{{E}_{b}}{{N}_{0}}$$

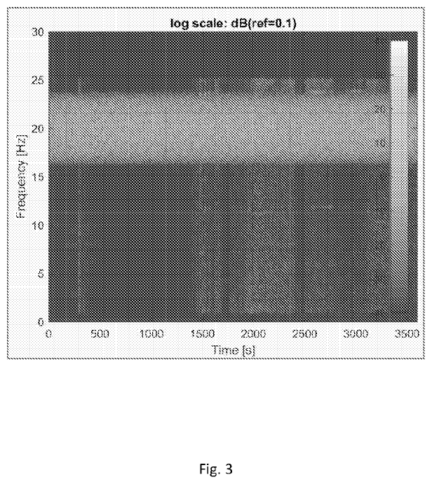

A spectrogram of the denoised test data from an optimized version of DDAE is shown in FIG. 3. For this illustrative embodiment, the SNR increased by 16.39 dB. The plot shows how the 20 Hz signal of interest is not filtered, while signals at other frequencies are filtered.

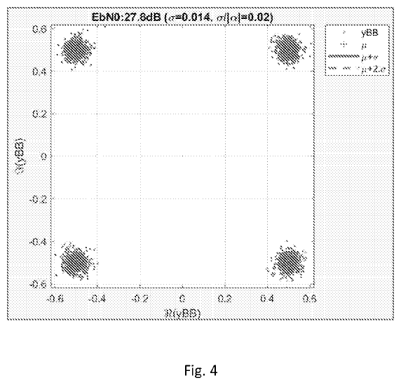

A demodulated constellation plot of denoised test data from an optimized version of DDAE is shown in FIG. 4. The Eb/NO increased by 4.10 dB. This confirms that the signal of interest is not filtered and that more signal energy than noise energy is received per bit.

Table 1 below provides the SNR and Eb/NO performance of different models. Removing the unsupervised portion of DDAE improved its performance (FS-DDAE). Converting DDUL to fully supervised (FS-DDUL) improved its performance. Removing patching from DDUL improved its performance (FS-RP-DDUL). Lastly, increasing the learning rate, switching to Stochastic Gradient Descent (SGD) optimizer, and reducing the batch size, all significantly improved the performance of both DDAE, and DDUL. Comparing fully supervised versions of DDAE and DDUL, both without patching mechanisms, allowed to analyze the impact of skip connections present in DDUL. The result is that DDAE provides higher SNR and Eb/NO, which means that removing skip connections improves the denoising performance in our dataset.

TABLE 1

| Model | SNR | Eb/N0 | Batch | Rate | Opt. |
|---|---|---|---|---|---|
| Input Data | 27.45 | 23.7 | — | — | — |
| FS-DDUL | 10.91 | 3.21 | 64 | 1E−03 | Adam |
| RP-DDUL | 26.79 | 22.9 | 16 | 1E−02 | SGD |
| FS-RP-DDUL | 29.21 | 26.5 | 16 | 1E−02 | SGD |
| FS-RP-DDUL | 29.47 | 20.9 | 64 | 1E−03 | Adam |
| FS-DDAE | 42.83 | 26.5 | 256 | 1E−04 | Adam |
| FS-DDAE | 44.95 | 27.8 | 8 | 1E−02 | SGD |

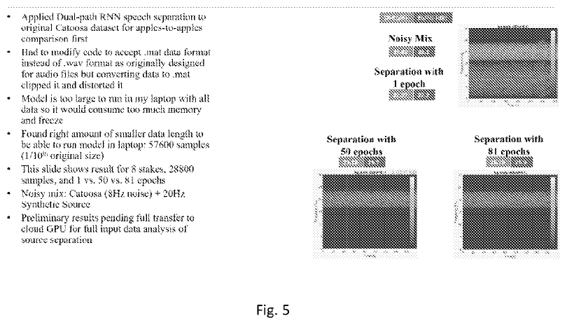

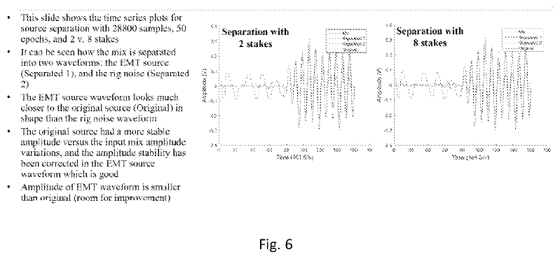

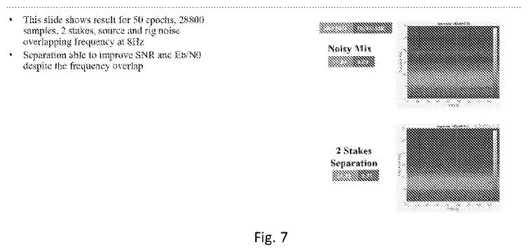

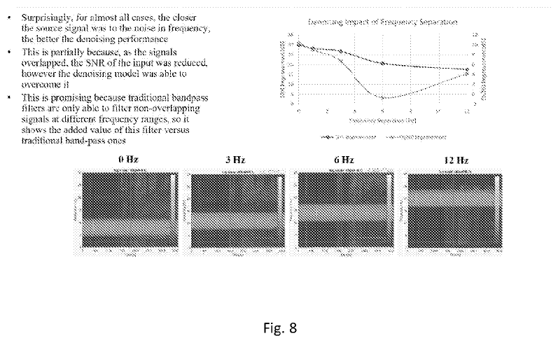

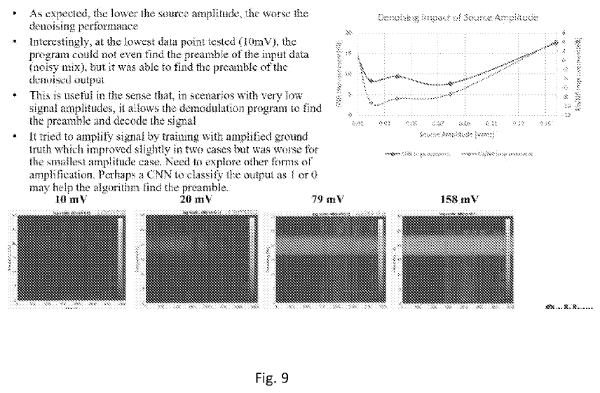

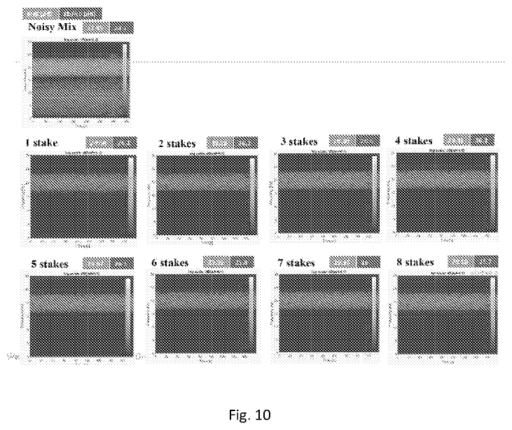

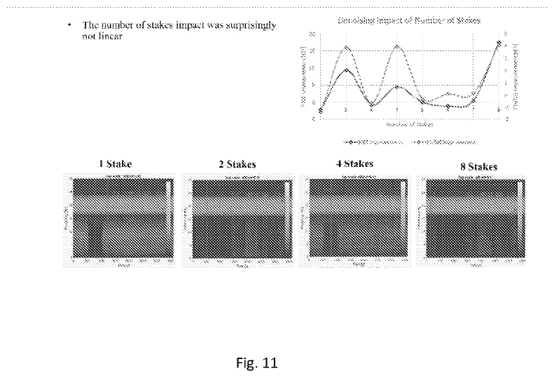

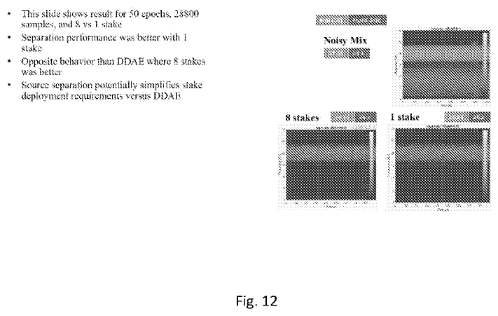

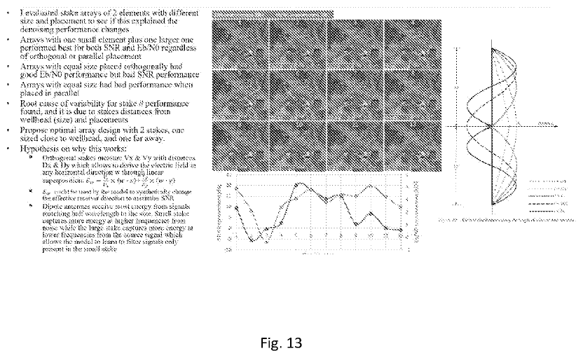

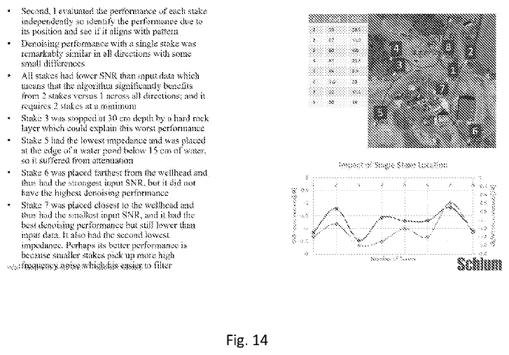

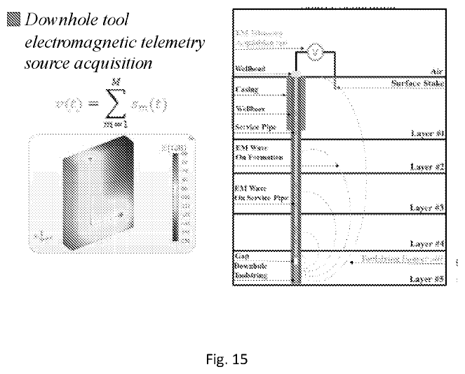

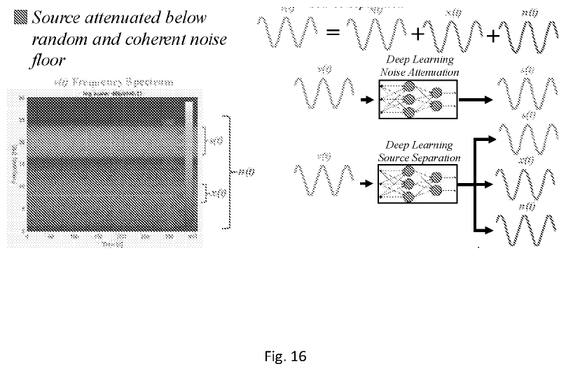

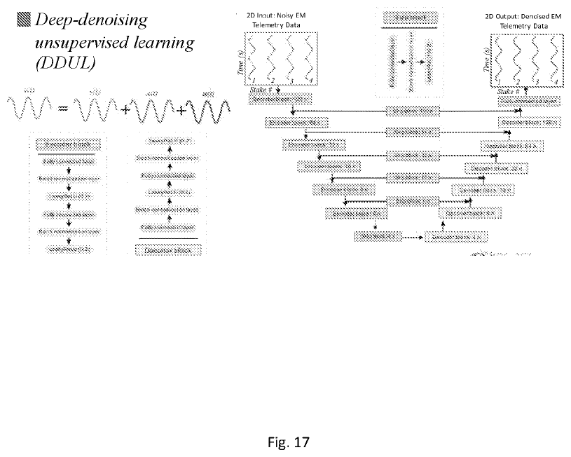

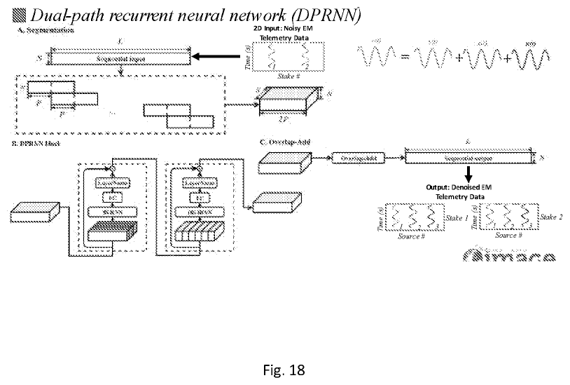

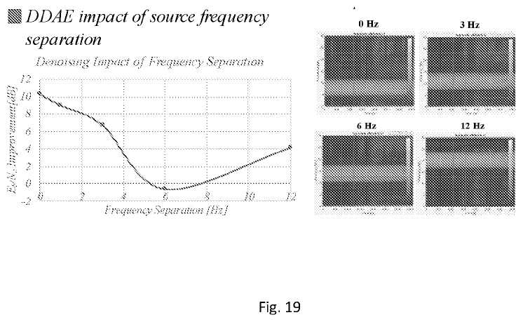

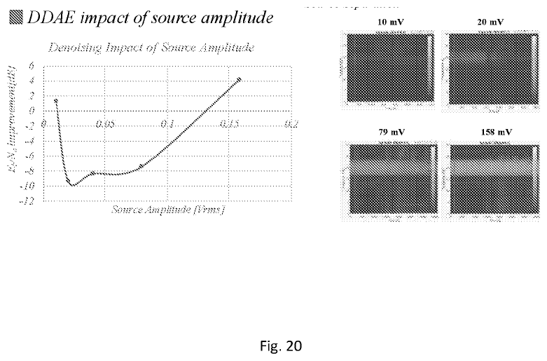

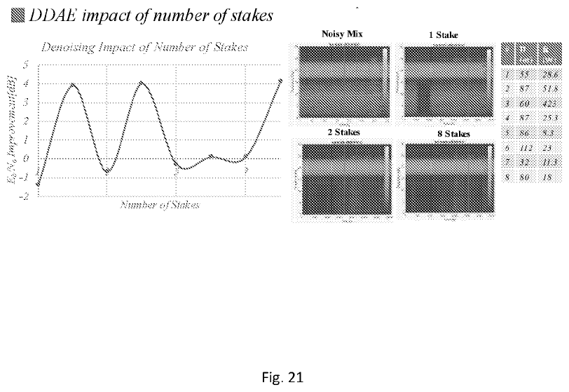

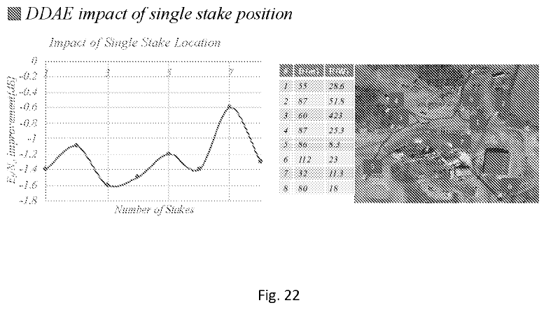

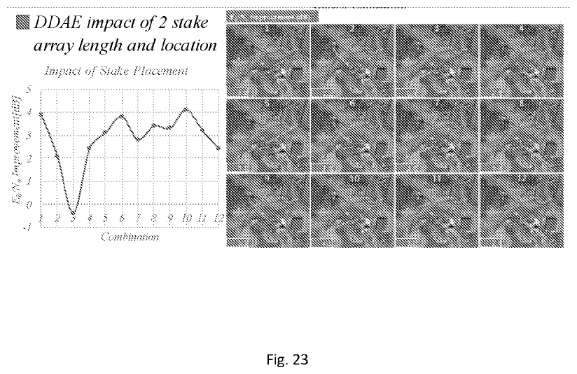

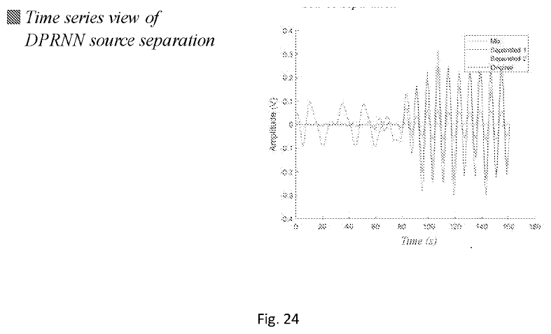

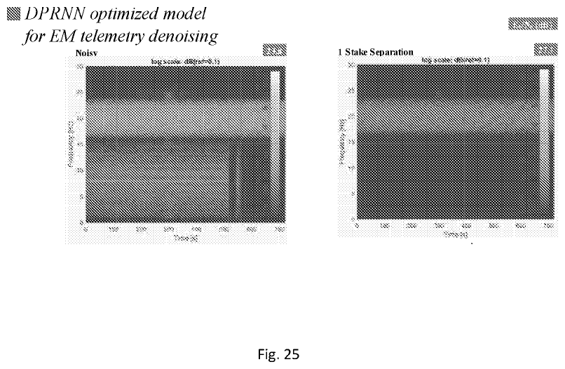

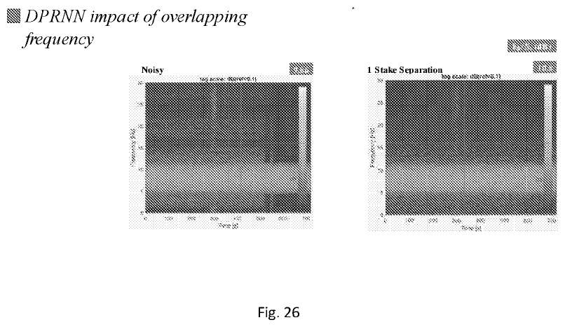

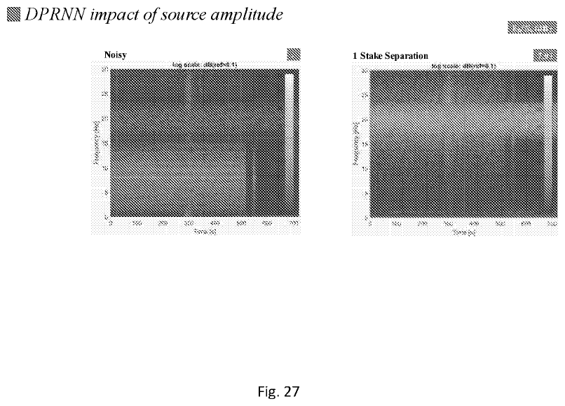

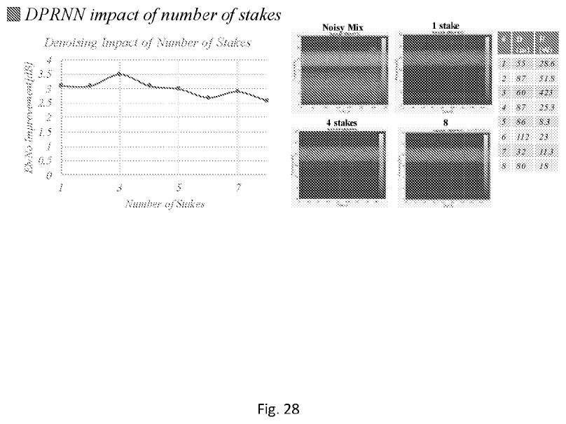

For this embodiment, a DL-based method is employed for random-noise attenuation within the EM telemetry signal band and subsequent source separation for EM downhole tool telemetry. The method takes advantage of the proven DDAE and DDUL architectures for noise attenuation of two-dimensional seismic time-domain data. Additionally, the method takes advantage of the proven DPT-Net architecture for end-to-end time-domain source separation. A dataset with mixed synthetic and field data may display that a fully supervised version of DDAE provides better SNR and Eb/NO test performance. Other efforts may take into account the DPT-Net and additional field and synthetic data sets. Quantitative estimation of SNR improvements may be evaluated for these different architectures in contrast to traditional signal processing approaches as illustrated in FIGS. 5-14 below. Additionally, FIGS. 15-28 illustrate various techniques for combining such approaches for improved EM signal transmission. This may include methods that combine noise attenuation and source separation. Embodiments may also include DDAE and DPRNN to attenuate random and coherent noise. Both DDAE and DPRNN have the capacity to attenuate random and coherent noise. When combined, both DDAE and DPRNN perform well even when noise and source are at the same frequency, providing further enhancement over traditional filters. Both DDAE and DPRNN improve SNR and Eb/No enough to enable demodulation of mixtures that may otherwise be too noisy to demodulate. DDAE outperforms with multiple stakes and overlapping frequencies. DPRNN provides best performance with one stake and severe attenuation. DPRNN provides best performance with one stake and severe attenuation. Additionally, further embodiments may explore reducing input window and model size.

Embodiments detailed hereinabove take advantage of conventionally available EM tools that may utilize dipole antenna designs, surface located stakes and voltage difference measurements between the stakes and the wellhead. However, in spite of signal losses through attenuation traversing the well and/or signal noise from a host of surface and other equipment, hardware and techniques are disclosed which allow for a degree of filtering and/or separation not previously available for EM oilfield communications. Thus, the processed EM readings may be of enhanced reliability such that resorting to added cabling, hardware, mud pulse and other less reliable or available communications modes may be avoided as a practical matter.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

We claim:

1. An electromagnetic telemetry system for communications between a downhole tool and surface equipment at an oilfield, the system comprising:
a downhole tool in a well with an electromagnetic communications module to support the communications;
a control unit of the surface equipment at the oilfield; and
a processor of one of the module and the control unit for management of the communications, the processor coupled to an architecture that includes an encoder for electromagnetic data compression to an abstraction and a decoder for attenuating of noise from the abstraction for filtering communication data.

2. The system of claim 1 wherein the data is obtained from the tool and from at least one stake located at a surface of the oilfield.

3. The system of claim 1 wherein the control unit further comprises a transformer to support separation of electromagnetic signal data from the encoder in advance of the filtering.

4. The system of claim 1 wherein the data comprises electromagnetic signals from the tool and the noise.

5. The system of claim 4 wherein the noise is noise from oilfield equipment at the surface.

6. A method for conveying electromagnetic communications in an environment between a downhole tool in a well at an oilfield and a control unit at a surface of the oilfield, the method comprising:
transmitting an electromagnetic signal between the tool and the unit; and
attenuating noise of the environment from the signal, the attenuating comprising:
encoding the noise and the signal at a database serving as an abstract space; and
utilizing a processor of the unit to run the abstracted noise and the signal through a decoder from the database for filtering the noise from the signal.

7. The method of claim 6 further comprising applying a speech separating technique to the signal in advance of utilizing the decoder to enhance the attenuating.

8. The method of claim 6 wherein the encoding is performed by a deep-denoising autoencoder of the unit.

9. The method of claim 8 further comprising utilizing training data for the encoding.

10. The method of claim 8 wherein the autoencoder employs a rectifier linear unit activation function for the encoding.

11. The method of claim 8 wherein the encoding is further performed by one of a deep-denoising unsupervised learning network and a supervised learning network of the unit.

12. The method of claim 11 wherein the deep-denoising unsupervised learning network employs a rectifier linear unit activation function with a predetermined leak.

13. The method of claim 11 further comprising utilizing skip blocks to extract electromagnetic telemetry data after the encoding and before running the signal through the decoder.

14. A method for conveying electromagnetic communications in an environment between a downhole tool in a well at an oilfield and a control unit at a surface of the oilfield, the method comprising:
transmitting an electromagnetic signal between the tool and the unit; and
attenuating noise of the environment from the signal by utilizing a processor of the unit for source separation between the signal and substantially all other electromagnetic data detections.

15. The method of claim 14 wherein the source separation is performed by a speech separation technique.

16. The method of claim 14 further comprising utilizing a transformer to support the source separation.

17. The method of claim 14 further comprising:
encoding the data to an abstraction from the unit in advance of the source separation; and
decoding the source separated data.

18. The method of claim 17 wherein the encoding employs one of a rectifier linear unit activation function and a rectifier linear activation function with a predetermined leak.

19. The method of claim 17 further comprising utilizing training data for the encoding.

20. The method of claim 17 further comprising utilizing skip blocks to extract electromagnetic data after the encoding and before the decoding.
